(19) United States
(12) Patent Application Publication
(10) Pub. No.: US 2023/0145373 A1
(43) Pub. Date: May 11, 2023

(54) POWER CONSUMPTION PREDICTION DEVICE, POWER CONSUMPTION PREDICTION METHOD AND POWER CONSUMPTION PREDICTION PROGAM

(71) Applicant: TOYOTA JIDOSHA KABUSHIKI KAISHA, Toyota-shi Aichi-ken (JP)

(72) Inventors: Daiki Yokoyama, Gotemaba-shi Shizuoka-ken (JP); Akihito Ito, Inazawa-shi Aichi-ken (JP); Ryo NAKABAYASHI, Susono-shi Shizuoka-ken (JP); Tatsuya Imamura, Okazaki-shi Aichi-ken (JP); Tomohiro Kaneko, Mishima-shi Shizuoka-ken (JP); Hiroki Murata, Gotemba-shi Shizuoka-ken (JP)

(73) Assignee: TOYOTA JIDOSHA KABUSHIKI KAISHA, Toyota-shi Aichi-ken (JP)

(21) Appl. No.: 17/981,790

(22) Filed: Nov. 7, 2022

(30) Foreign Application Priority Data
Nov. 10, 2021 (JP) 2021-183727

(51) Int. Cl. G06F 1/3209; G06F 1/3231

(52) U.S. Cl. CPC G06F 1/3209; G06F 1/3231

(57) ABSTRACT

A device for predicting power consumption in a predetermined target area includes: an attribute specifying unit for specifying an attribute of a person within the predetermined target area; and a prediction unit for calculating a predicted power consumption in the target area based on the specified attribute such that the predicted power consumption in the target area differs when the attribute of the person differs.

### CROSS REFERENCE TO RELATED APPLICATION

This application claims the benefit of priority from Japanese Patent Application No. 2021-183727 filed on Nov. 10, 2021, which is incorporated herein by reference in its entirety.

### TECHNICAL FIELD

The present disclosure relates to a power consumption prediction device, a power consumption prediction method, and a power consumption prediction program.

### BACKGROUND

In smart cities, it has been proposed to collect data from multiple entities within the community. In particular, in JP2013-069084A1, since there is uncertainty in data obtained from information systems of different business entities, it has been proposed to collect data obtained by correcting the obtained data in order to solve the uncertainty.

In a target area such as a smart city, various power storage devices such as a vehicle parked in the target area are used. When the power consumption of the entire target area is small, the power is charged to the power storage device, and when the power consumption of the entire target area is large, the power is discharged from the power storage device. In order to properly control such power in the target area, it is necessary to accurately predict the power consumption in the target area.

In view of the above problems, it is an object of the present disclosure to accurately predict power consumption in a target area.

### SUMMARY

(1) A power consumption predicting device for predicting power consumption in a predetermined target area, the power consumption predicting apparatus comprising an attribute specifying unit for specifying an attribute of a person within the predetermined target area; and a prediction unit for calculating a predicted power consumption in the target area based on the specified attribute, wherein the prediction unit calculates the predicted power consumption in the target area so that the predicted power consumption in the target area differs when the attribute of the person differs.

(2) The power consumption prediction apparatus of above (1), wherein the attributes of the person are distinguished by a predicted stay period during which the person stays in the target area.

(3) The power consumption prediction apparatus according to above (2), wherein the attribute of the person includes which of a short-term visitor whose predicted stay period is less than a predetermined reference period and a long-term resident whose predicted stay period is equal to or longer than the predetermined reference period, the person belongs to.

(4) The power consumption prediction apparatus according to any one of above (1) to (3), wherein the prediction unit calculates a predicted power consumption in the target area using a machine learning model in which a parameter related to an attribute of the person is an input parameter and a power consumption by the person or a power consumption in the target area is an output parameter.

(5) The power consumption predicting apparatus according to any one of above (1) to (3), wherein the prediction unit calculates the predicted personal power consumption of each person using a machine learning model for each person, calculates the predicted power consumption of the target area based on a value obtained by summing the predicted personal power consumption of all persons in the target area, and uses a machine learning model different for each attribute of a person when calculating the predicted personal power consumption.

(6) A power consumption prediction method for predicting power consumption in a predetermined target area, the method comprising specifying an attribute of a person in the predetermined target area; and calculating a predicted power consumption in the target area based on the specified attribute, wherein the predicted power consumption is calculated such that the predicted power consumption in the target area differs when the attribute of the person differs.

(7) A power consumption prediction program for predicting power consumption in a predetermined target area, the power consumption prediction program causing a computer to execute specifying an attribute of a person in the predetermined target area; and calculating a predicted power consumption in the target area based on the specified attribute, wherein the predicted power consumption is calculated so that the predicted power consumption in the target area differs when the attribute of the person differs.

### BRIEF DESCRIPTION OF THE DRAWINGS

FIG. 1 is a schematic configuration diagram of a power consumption prediction system.

FIG. 2 is a diagram schematically showing a hardware configuration of a server.

FIG. 3 is a functional block diagram of a processor of the server.

FIG. 4 is a flowchart showing a flow of power consumption prediction processing.

FIG. 5 is a diagram schematically showing a machine learning model used by a prediction unit.

FIG. 6 is a diagram schematically showing a machine learning model used by the prediction unit.

FIG. 7 is a flowchart showing a flow of power consumption prediction processing.

FIG. 8 is a diagram schematically showing a machine learning model used by the prediction unit.

### DETAILED DESCRIPTION

Hereinafter, embodiments will be described in detail with reference to the drawings. In the following description, similar components are denoted by the same reference numerals.

### First Embodiment

Configuration of Power Consumption Prediction System

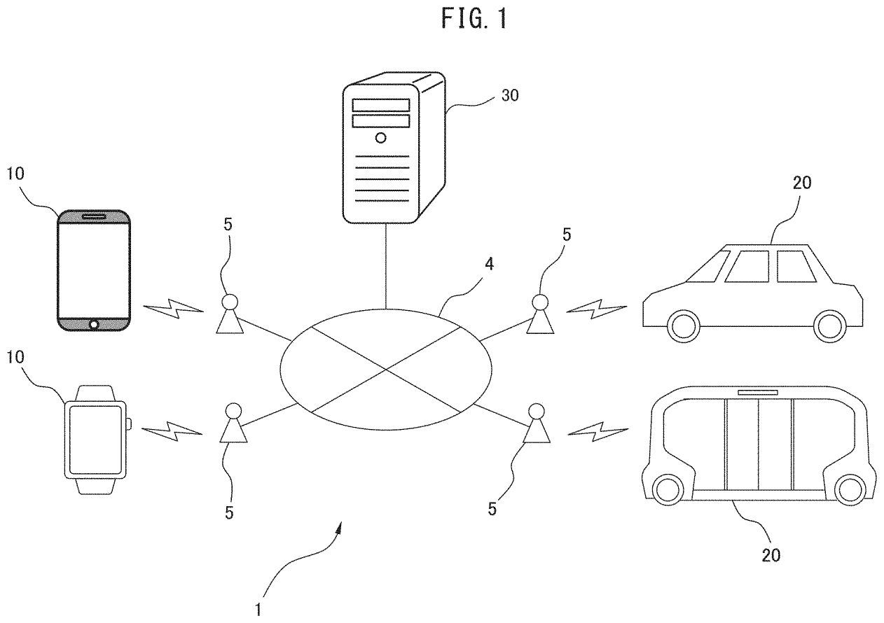

Referring to FIGS. 1 to 3, a configuration of a power consumption prediction system 1 according to a first embodiment will be described. FIG. 1 is a schematic configuration diagram of the power consumption prediction system 1. The power consumption prediction system 1 predicts the power consumption in the target area using the machine learning model in the server.

As shown in FIG. 1, the power consumption prediction system 1 includes a plurality of terminal devices 10, a plurality of operating devices (in the illustrated example, vehicles) 20, and a server 30 capable of communicating with the terminal devices 10 and the operating devices 20. Each of the plurality of terminal devices 10 and the operating devices 20 and the server 30 are configured to be able to communicate with each other via a communication network 4 configured by an optical communication line or the like and a radio base station 5 connected to the communication network 4 via a gateway (not shown). As the communication between the terminal device 10 and the radio base station 5, various wide area wireless communication having a long communication distance can be used, for example, communication that conforms to any communication standard such as 4G, LTE, or 5G, WiMAX established by 3GPP, IEEE is used. Also, the operating device 20 may be connected to the communication network 4 by wire instead of wirelessly.

In particular, in the present embodiment, the server 30 communicates with the terminal device 10 and the operating device 20 located within a predetermined target area. The target area is a range surrounded by predetermined boundaries. For example, a smart city is defined as “a sustainable city or region that solves various problems faced by cities and regions and continues to create new value, through the sophistication of management (planning, maintenance, management, operation, etc.) while utilizing new technologies such as ICT (information and communication technology).” The server 30 may be capable of communicating with the terminal device 10 and the operating device 20 located outside the target area.

Each of the terminal devices 10 is a device that is held by an individual and acquires data of the individual holding the terminal device 10. In particular, in the present embodiment, the terminal device 10 functions as a mobile data acquisition device that acquires personal data in a predetermined target area or an area around the target area. Therefore, in the present embodiment, the terminal device 10 moves along with the movement of the individual holding the terminal device 10. Therefore, when an individual holding the terminal device 10 moves into the target area, the terminal device 10 held by the individual also moves into the target area. Conversely, when an individual holding the terminal device 10 moves out of the target area, the terminal device 10 held by the individual also moves out of the target area.

Specifically, in the present embodiment, the terminal device 10 includes, for example, a wearable terminal such as a watch type terminal (smart watch), a wristband type terminal, a clip type terminal, and an eyeglass type terminal (smart glass), and a portable terminal. The terminal device 10 acquires personal data including, for example, personal information (identification information such as ID, gender, age, etc.) of the person holding the terminal device 10, and positional information (positional information of the terminal device 10) of the person holding the terminal device 10. Terminal device 10 transmits the personal data acquired in this way to the server 30.

The operating device 20 operates in accordance with a command from the server 30. In particular, the operating device 20 includes various devices located within a target area. Specifically, the operating device 20 includes, devices relating to power storage, power generation, and discharging, such as, for example, an electric vehicle, a power generation device, a power storage device, and the like in the target area.

The server 30 is connected to a plurality of terminal devices 10 and operating devices 20 via the communication network 4. In the present embodiment, the server 30 executes processing using a machine learning model. The server 30 predicts the power consumption in the target area.

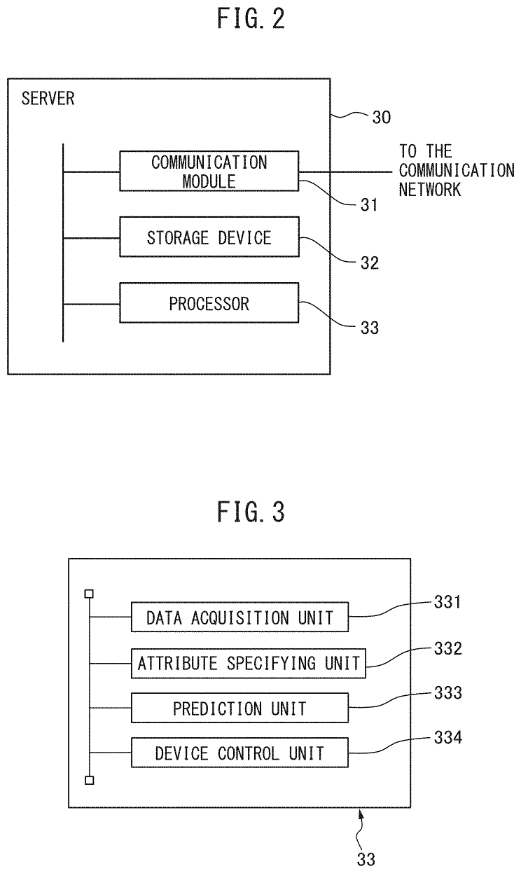

FIG. 2 is a diagram schematically showing a hardware configuration of the server 30. The server 30 includes a communication module 31, a storage device 32, and a processor 33, as shown in FIG. 2. The server 30 may include input devices such as a keyboard and a mouse, and output devices such as a display and a speaker.

The communication module 31 is an example of a communication device for communicating with devices outside the server 30. The communication module 31 comprises an interface circuit for connecting the server 30 to the communication network 4. The communication module 31 is configured to communicate with each of the plurality of terminal devices 10 and the operating devices 20 via the communication network 4 and the radio base station 5.

The storage device 32 is an example of a storage device for storing data. The storage device 32 includes, for example, a hard disk drive (HDD), a solid state drive (SSD), or an optical recording medium. The storage device 32 may include a volatile semiconductor memory (e.g., RAM), a nonvolatile semiconductor memory (e.g., ROM), or the like. The storage device 32 stores a computer program for executing various processing by the processor 33 and various data used when various processing is executed by the processor 33. In particular, the storage device 32 stores data received from the terminal device 10, data related to the machine learning model (e.g., configuration of the machine learning model and model parameters such as weights, biases, etc.), and data used for processing using the machine learning model.

The processor 33 has one or a plurality of CPUs and peripheral circuits thereof. The processor 33 may further comprise a GPU or an arithmetic circuit such as a logical or numerical unit. The processor 33 executes various kinds of processing based on a computer program stored in the storage device 32. In particular, in the present embodiment, the processor 33 functions as a power consumption predicting apparatus for predicting the power consumption in the target area.

FIG. 3 is a functional block diagram of a processor 33 of the server 30. As shown in FIG. 3, the processor 33 includes a data acquisition unit 331 for acquiring various data including data relating to the attributes of the person in the target area, an attribute specifying unit 332 for specifying the attributes of the person in the target area, a prediction unit 333 for calculating the predicted power consumption in the target area based on the specified attributes, and a device control unit 334 for controlling the operating device 20 based on the calculated predicted power consumption. These functional blocks of the processor 33 of the server 30 are functional modules implemented, for example, by computer programs running on the processor 33. Alternatively, the functional blocks included in the processor 33 may be dedicated arithmetic circuits provided in the processor 33. The details of each of these functional blocks will be described later.

### Outline of Power Consumption Prediction

Next, an outline of the power consumption prediction in the power consumption prediction system 1 will be described. In a target area such as a smart city, it is expected that various devices in the target area are connected by communication, thereby solving various existing problems in the target area. On the other hand, power is consumed to electronically connect various devices and also to acquire information in various devices.

In general, power consumption is higher in the daytime than in the nighttime, but it is not always possible to control the amount of power generated in the power generation facility to match the amount of power consumption. Therefore, the amount of power generation and the amount of power consumption in the power generation facility do not necessarily coincide with each other. Therefore, in order to manage the supply and demand of electric power in the target area, it is necessary to appropriately control the equipment related to power storage, generation and discharge in the target area, based on the predicted electric power consumption in the future. Therefore, in the present embodiment, the power consumption in the target area is predicted.

Here, the power in the target area includes electric power consumed independently of a person in the target area (e.g., electric power used in street lamps, traffic lights, or the like) and electric power consumed in association with a person in the target area (e.g., electric power used in lighting, television, or the like in the home). The power consumed independently of the person in the target area is easy to predict because the period and amount of power consumed are predetermined. On the other hand, the power consumed in association with the person in the target area is difficult to predict because it depends on the behavior of the person. For this reason, in the present embodiment, the power consumption prediction system 1 particularly predicts the amount of power consumed in association with a person in the target area using the machine learning model.

The power consumed by a person within the target area varies depending on a variety of factors. Specifically, the electric power consumed by the person in the target area changes in accordance with, for example, the temperature, humidity, the presence or absence of an event in the target area, the type of the event, the attributes of the person in the target area, and the like. For example, when the air temperature and humidity in the target area are high, the probability that the person in the target area uses the air conditioning apparatus is increased. Thus the amount of power consumed by each person increases. In addition, when an event is held in the target area, power is consumed in the event, and therefore, the amount of power consumed by a person who participates in the event increases.

The attributes of a person also include, for example, whether a person is a short-term visitor whose expected period of stay in the target area is less than a predetermined reference period (e.g., a period spanning the night) or a long-term resident whose expected period of stay is not less than the reference period. The short-term visitors include, in particular, visitors who have not settled in the target area and are not scheduled to stay overnight therein. On the other hand, the long-term residents include, for example, visitors who are not settled in the target area and are scheduled to stay over nights in the target area, and residents who are settled in the target area. Since the tendency of action in the target area is greatly different between the short-term visitor and the long-term resident, the amount of electric power consumed in the target area is also different. For example, a short-term visitor has a low probability of staying in a target area across nights, and thus consumes less power consumption at least at nighttime than a long-term resident. The attributes of a person may also include various other parameters such as the person's gender, age, place of work, etc.

In the present embodiment, the attributes of the person are distinguished based on whether the person stays in the target area for a short period of time or for a long period of time. However, the attributes of a person may be distinguished in other manners as long as they are distinguished by the expected duration of stay in the target area. Specifically, the attributes of a person may be distinguished based on, for example, whether the expected stay period is 6 hours, half a day, one day, or more than one day, respectively.

Therefore, in the present embodiment, the power consumed by the person in the target area is estimated based on various parameters including the temperature, the humidity, the presence or absence of an event in the target area, the type of the event, and the attributes of the person in the target area. Attributes of persons in the target area include whether they are short-term visitors or long-term residents, gender, age, place of work, and the like.

In the present embodiment, the power consumption prediction system calculates the predicted power consumption amount that is expected to be consumed by a person in the target area, based on the attributes of the person in the target area, and predicts the power consumption amount in the entire target area based on the calculated predicted power consumption amount. This makes it possible to accurately predict the power consumption in the entire target area.

### Power Consumption Prediction Processing and Equipment Control Processing

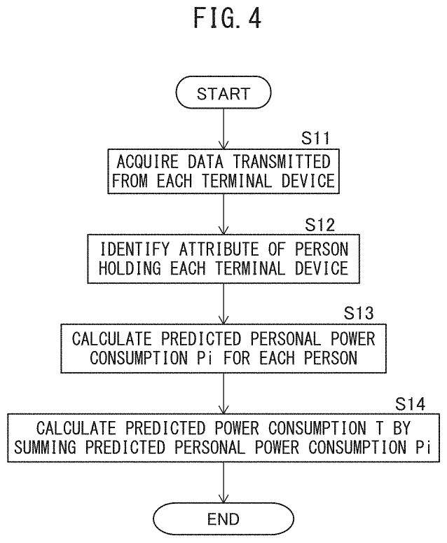

With reference to FIG. 4, a power consumption prediction process for predicting the power consumption in the target area, the device control process for controlling the operating device based on the predicted power consumption will be described. FIG. 4 is a flowchart showing a flow of power consumption prediction process. The power consumption prediction process is executed by the processor 33 of the server 30.

As shown in FIG. 4, first, the data acquisition unit 331 of the processor 33 acquires various types of data including data transmitted from each terminal device 10 (Step S11). Here, the terminal device 10 periodically transmits the personal data acquired by and stored in the terminal device 10 to the server 30. Specifically, the terminal device 10 transmits, for example, personal information (identification information, gender, age, etc.) of the person held in the terminal device 10 and positional information (i.e., positional information of the person holding the terminal device 10) of the terminal device 10 to the server 30. The personal data transmitted from the terminal device 10 in this way is stored in the storage device 32 of the server 30.

Various data other than the above-mentioned personal data may be transmitted to the server 30 from a device other than the above-mentioned mobile terminal device 10. Data relating to the predicted air temperature and humidity in the target area is transmitted to the server 30, for example, from a device of a predicting organization that predicts the air temperature and humidity. Alternatively, data relating to an image or a moving image captured by a surveillance camera disposed in the target area is transmitted to the server 30. Various data transmitted from the various terminals in this manner is also stored in the storage device 32 of the server 30.

The data acquisition unit 331 of the processor 33 acquires only the data necessary for calculating the power consumption of the target area among the data stored in the storage device 32 of the server 30 from the storage device 32 in the above way.

Next, the attribute specifying unit 332 of the processor 33 specifies the attribute of the person in the target area, based on the data acquired by the data acquisition unit 331 (Step S12). In the present embodiment, identification information of a person who has settled in the target area and a person who intends to stay in the target area (i.e., a long-term resident) is registered in advance, and the identification information is stored in the storage device 32 of the server 30. Therefore, the attribute specifying unit 332 checks the identification information included in the data transmitted from each terminal device 10 with the pre-registered identification information stored in the storage device 32 of the server 30, and specifies whether or not the person holding the terminal device 10 is a long-term resident. Specifically, when the identification information included in the data transmitted from each terminal device 10 is included in the pre-registered identification information, the attribute specifying unit 332 specifies that the person holding the terminal device 10 is a long-term resident. On the other hand, when the identification information included in the data transmitted from each terminal device 10 is not included in the pre-registered identification information, the attribute specifying unit 332 specifies that the person holding the terminal device 10 is a short-term visitor.

In the present embodiment, the attribute specifying unit 332 specifies whether each person in the target area is a long-term resident or a short-term visitor, based on the identification information included in the data transmitted from the terminal device 10. However, the attribute specifying unit 332 may specify whether each person in the target area is a long-term resident or a short-term visitor by another method.

For example, when it is mandatory to attach a badge according to the stay period to a person staying in the target area, the attribute specifying unit 332 recognizes the type of the person and the badge represented in the image captured by the surveillance camera by the image recognition processing, and specifies whether the recognized person is a long-term resident or a short-term visitor on the basis of the recognized type of the badge. In this case, the personal data such as the gender and age of the recognized person is specified by the image recognition processing. Therefore, in this case, personal data may not be transmitted from each terminal device 10.

After that, the prediction unit 333 of the processor 33 calculates the predicted personal power consumption that is predicted to be consumed by each person in the target area, based on the data including the attribute of the person specified by the attribute specifying unit 332 (Step S13). In the present embodiment, the predicted individual power consumption of each person in the target area is calculated by the machine learning model.

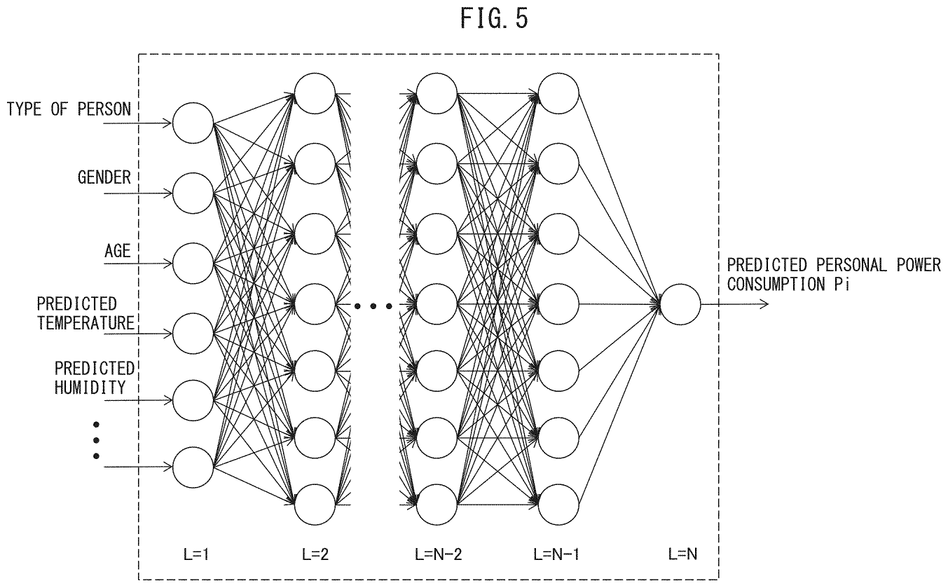

FIG. 5 is a diagram schematically showing a machine learning model used by the prediction unit 333. As shown in FIG. 5, in the present embodiment, the machine learning model is configured by an N-layer neural network. In the machine learning model shown in FIG. 5, when values of input parameters including the type of person (whether the person is a long-term resident or a short-term visitor), a gender of the person, an age of the person, a predicted temperature of the target area, a predicted humidity of the target area, and the like are input, and the predicted personal electric power consumption Pi of the person is output. The predicted personal power consumption amount Pi may be an amount of power that is predicted to be consumed by the person from the present to a predetermined time later, or may be an amount of power that is predicted to be consumed by the person every predetermined time interval (for example, every hour) (an amount of power for every predetermined time). Incidentally, in FIG. 5, L=1 is the input layer, L=2, L=N−2 and L=N−1 are hidden layers, L=N is the output layer, respectively.

The model parameters of the machine learning model (such as hyper-parameters, weights, and biases) are calculated in advance by training. The training of the model parameters of the machine learning model is performed using a known technique such as the error backpropagation method based on the training data including the measured values of the input parameters of the machine learning model and the measured values of the output parameters of the machine learning model.

In the present embodiment, the machine learning model uses a neural network (NN) having only fully connected layers, but may use a convolutional neural network (CNN) having a convolution layer or a recurrent neural network (RNN) having a recurrent layer. In the present embodiment, the machine learning model uses a neural network, but other supervised learning algorithms such as a support vector machine (SVM) and a decision tree (DT) may be used.

In the present embodiment, the input parameters of the machine learning model include the type of person, the gender, the age, the predicted air temperature, and the predicted humidity, but the input parameters may include any other parameters as long as the input parameters include the type of person. Thus, the input parameters may include various parameters such as the current time, date, weather, presence or absence of an event, its type, and the place of work of a person.

Then, the prediction unit 333 of the processor 33 calculates the predicted power consumption in the target area, based on the predicted personal power consumption (Step S14). Specifically, the prediction unit 333 calculates the predicted power consumption T in the target area by summing the predicted personal power consumptions Pi for all persons in the target area based on the following equation (1).

$$T = {\sum }_{i = 1}^{M} P i \qquad ( 1 )$$

In the above equation (1), Pi represents the estimated personal power consumption of the i-th person (i=1, 2, . . . , M) in the target area, and M represents the number of persons in the target area. The predicted power consumption T may be an amount of power that is predicted to be consumed in the target area from the present to a predetermined time later, or an amount of power that is predicted to be consumed in the target area every predetermined time (e.g., every hour) (the amount of power for each predetermined time).

In the above embodiment, the prediction unit 333 calculates the value obtained by summing the predicted personal power consumption Pi, as the predicted power consumption T in the target area. However, the value obtained by summing the predicted personal power consumption Pi represents the power consumed in association with persons in the target area, and does not include the power consumed independently of persons in the target area. Therefore, the prediction unit 333 may calculate a value obtained by adding the predicted value of the power consumed independently of the person in the target area to the total value calculated in the above manner, as the predicted power consumption T in the target area.

As described above, in the present embodiment, the prediction unit 333 calculates the predicted power consumption T in the target area using the machine learning model in which the parameter related to the attribute of each person is the input parameter and the predicted personal power consumption Pi by the person is the output parameter. As a result, the predicted personal power consumption will be different from the human attribute, and thus the predicted power consumption in the target area will be different. In particular, in the present embodiment, the prediction unit 333 calculates the predicted personal power consumption of each person using the machine learning model for each person, and calculates the predicted power consumption based on a value obtained by summing the calculated personal power consumption of all persons in the target area.

When the predicted power consumption in the target area is calculated in this way, the device control unit 334 of the processor 33 controls the operating device 20 in the target area, based on the calculated predicted power consumption. Specifically, the device control unit 334 controls the power generation amount in the power generation device in the target area, and controls the power storage amount in the power storage device in the target area. Further, when the electric power stored in the battery of the electric vehicle in the target area can be supplied to other than the electric vehicle, the device control unit 334 may control the amount of stored electric power of the electric vehicle in the target area.

Specifically, for example, when the predicted power consumption T is large, the device control unit 334 controls the power storage amount of the power storage device and the electric vehicle so as to store a relatively large amount of power in the power storage device or the electric vehicle. Further, in this case, in order to store electricity in the power storage device or the electric vehicle, the power generation device is controlled so that the power generation amount of the power generation device increases.

### Second Embodiment

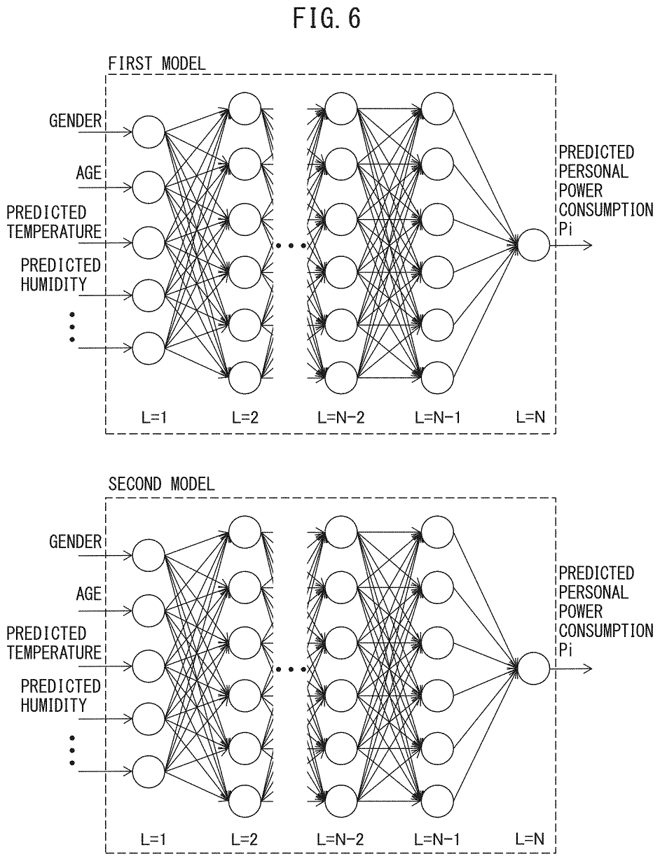

Next, with reference to FIG. 6, a power consumption prediction system 1 according to the second embodiment will be described. The configuration and operation of the power consumption prediction system according to the second embodiment are basically the same as the configuration and operation of the power consumption prediction system according to the first embodiment. It will be described below mainly different portions from the power consumption prediction system according to the first embodiment.

In the first embodiment, the type of person (whether it is a long-term resident or a short-term visitor) is used as an input parameter to the machine learning model. On the other hand, in the present embodiment, the type of person is not used as an input parameter to the machine learning model. Instead, in the present embodiment, a different machine learning model is used for each type of person.

FIG. 6 is a diagram schematically showing a machine learning model used by the prediction unit 333 in the second embodiment. In the present embodiment, the prediction unit 333 uses a plurality of machine learning models different for each type of person. In the example shown in FIG. 6, the prediction unit 333 uses two machine learning models, a first model for long-term residents and a second model for short-term visitors. In the case where the type of person is divided into three or more, the prediction unit 333 uses the number of machine learning models corresponding to the divided number.

As shown in FIG. 6, also in the present embodiment, the machine learning model is configured by an N-layer neural network. However, the type of person is not used as an input parameter for any of the machine learning models. Therefore, in each machine learning model shown in FIG. 6, when the value of the input parameter including the person's gender, the person's age, the predicted temperature of the target area, the predicted humidity of the target area, and the like is input, the predicted personal power consumption Pi of that person is output.

As described above, in the present embodiment, the prediction unit 333 calculates the predicted personal power consumption of each person using the machine learning model for each person, and calculates the predicted power consumption based on a value obtained by summing the calculated personal power consumption of all persons in the target area. When calculating the predicted personal power consumption, the prediction unit 333 uses machine learning models that differ for each attribute of the person. Thus, according to the present embodiment, it is possible to estimate the predicted personal power consumption Pi with high accuracy, and thus the predicted power consumption T in the target area with higher accuracy.

### Third Embodiment

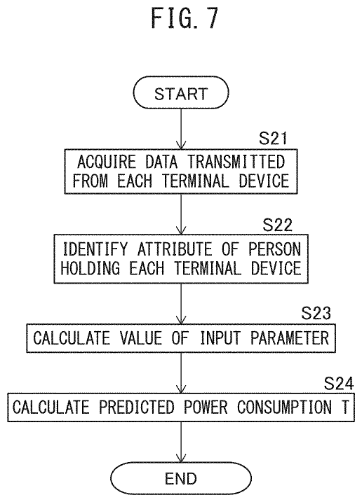

Next, with reference to FIG. 7, a power consumption prediction system 1 according to the third embodiment will be described. The configuration and operation of the power consumption prediction system according to the third embodiment are basically the same as the configuration and operation of the power consumption prediction system according to the first embodiment and the second embodiment. A description will now be given focusing on a portion different from the power consumption prediction system according to the first embodiment and the second embodiment.

In the first embodiment and the second embodiment, the predicted personal power consumption of each person in the target area is calculated using the machine learning model, and the predicted power consumption in the target area is calculated based on the value obtained by summing the calculated predicted personal power consumption. On the other hand, in the present embodiment, the predicted power consumption in the target area is directly calculated using the machine learning model.

FIG. 7 is a flowchart showing a flow of power consumption prediction processing in the third embodiment. Steps S21 and S22 in FIG. 7 are the same as steps S11 and S12 in FIG. 4, and therefore description thereof is omitted.

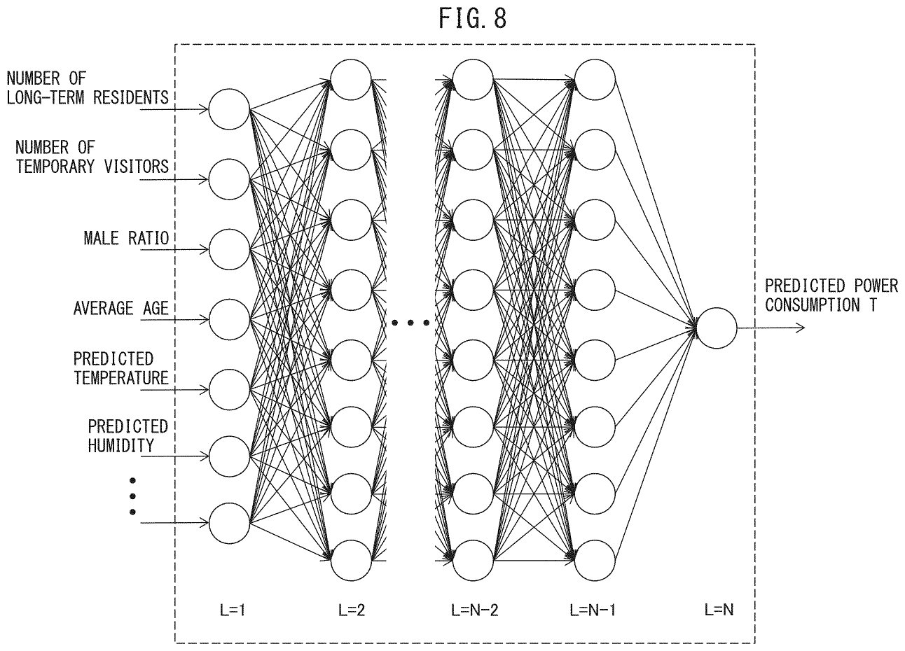

When the attribute of the person in the target area is specified in step S22, the prediction unit 333 calculates the value of the input parameter of the machine learning model (step S23). Here, in the present embodiment, the personal data of each person in the target area is not input as it is, but the aggregated values of the parameters of these personal data are used as inputs to the machine learning model. Specifically, in the present embodiment, as shown in FIG. 8, the number of long-term residents in the target area, the number of short-term visitors in the target area, the ratio of males or females in the target area, the average age of persons in the target area, and the like are input as input parameters to the machine learning model. Accordingly, the prediction unit 333 calculates the values of the input parameters, based on the data acquired by the data acquisition unit 331 and the attribute (the type of the person) specified by the attribute specifying unit 332.

When the value of the input parameter of the machine learning model is calculated in step S23, the prediction unit 333 calculates the predicted power consumption in the target area based on the calculated value of the input parameter (step S24). In this embodiment, the predicted power consumption in the target area is calculated by the machine learning model.

FIG. 8 is a diagram schematically showing a machine learning model used by the prediction unit 333. As shown in FIG. 8, also in the present embodiment, the machine learning model is configured by an N-layer neural network. In the machine learning model shown in FIG. 8, when values of input parameters including the number of long-term residents in the target area, the number of short-term visitors in the target area, the ratio of males or females in the target area, the average age of the persons in the target area, the predicted air temperature of the target area, the predicted humidity of the target area, and the like are input, the predicted power consumption T in the target area is output.

As described above, in the present embodiment, the prediction unit 333 calculates the predicted power consumption in the target area using the machine learning model in which the parameters relating to the attributes of each person, such as the number of long-term residents and the number of short-term visitors, are input parameters and the power consumption in the target area is an output parameter. As a result, different human attributes result in different predicted power consumption in the target area. This eliminates the need to perform calculations using the machine learning model for the number of persons in the target area, thereby reducing the computational load on the server 30.

While embodiments of the present disclosure have been described above, the present disclosure is not limited to these embodiments, and various modifications and changes may be made within the scope of the appended claims.

1. A device for predicting power consumption in a target area, the device comprising a processor configured to:
specify an attribute of a person within the target area; and
calculate a predicted power consumption in the target area based on the specified attribute such that the predicted power consumption in the target area differs when the specified attribute of the person differs, wherein
the attribute of the person includes which of a short-term visitor whose predicted stay period during which the person stays in the target area is less than a predetermined reference period over a night and a long-term resident whose predicted stay period is equal to or longer than the predetermined reference period, the person belongs to.

2. The device of claim 1, wherein the processor is further configured to calculate the predicted power consumption in the target area using a machine learning model in which a parameter related to the attribute of the person is an input parameter and a power consumption by the person or a power consumption in the target area is an output parameter.

3. The device of claim 1, wherein the processor is further configured to:
calculate a predicted personal power consumption of each person using a machine learning model for each person,
calculate the predicted power consumption of the target area based on a value obtained by summing the predicted personal power consumption of all persons in the target area, wherein
a different machine learning model is used for each attribute of the person when calculating the predicted personal power consumption.

4. A method for predicting power consumption in a target area, the method comprising:
specifying an attribute of a person in the target area; and
calculating a predicted power consumption in the target area based on the specified attribute such that the predicted power consumption in the target area differs when the attribute of the person differs, wherein
the attribute of the person includes which of a short-term visitor whose predicted stay period during which the person stays in the target area is less than a predetermined reference period over a night and a long-term resident whose predicted stay period is equal to or longer than the predetermined reference period, the person belongs to.

5. A non-transitory computer readable medium having recorded thereon a program for predicting power consumption in a target area, the program including machine-readable instructions that cause a computer to execute:
specifying an attribute of a person in the target area; and
calculating a predicted power consumption in the target area based on the specified attribute such that the predicted power consumption in the target area differs when the attribute of the person differs, wherein
the attribute of the person includes which of a short-term visitor whose predicted stay period during which the person stays in the target area is less than a predetermined reference period over a night and a long-term resident whose predicted stay period is equal to or longer than the predetermined reference period, the person belongs to.
